(19) United States
(12) Patent Application Publication
(10) Pub. No.: US 2009/0300346 A1
(43) Pub. Date: Dec. 3, 2009

(54) Device and Method for Identifying Certificates

(76) Inventors: Kashyap MERCHANT, Santa Clara, CA (US); Jack Cai, San Jose, CA (US); Sanjiv Maurya, Fremont, CA (US)

Correspondence Address: MOTOROLA INC, 600 NORTH US HIGHWAY 45, W4 - 39Q, LIBERTYVILLE, IL, 60048-5343, US

(21) Appl. No.: 12/236,983

(22) Filed: Sep. 24, 2008

Related U.S. Application Data
(60) Provisional application No. 61/057,598, filed on May 30, 2008.

(51) Int. Cl. H04L 9/32

(52) U.S. Cl. 713/152; 713/155

(57) ABSTRACT

A device and method identifies a certificate. The method comprises determining, by a transmitter of data, an identity of a recipient of the data. The method comprises identifying a certificate associated with the identity. The identifying includes a local search and a remote search. The method comprises encrypting the data according to the certificate prior to transmission.

### PRIORITY CLAIM

This application claims the priority to the U.S. Provisional Application Ser. No. 61/057,598, entitled “Device and Method for Identifying Certificates,” filed May 30, 2008. The specification of the above-identified application is incorporated herewith by reference.

### BACKGROUND INFORMATION

A certificate may be used to transmit data from a first computing device to a second computing device. The certificate may be part of a security arrangement where the data is encrypted by the first computing device and decrypted by the second computing device. The certificate contains a public key and a private key pair. The public key may be known by any transmitting device such as the first computing device to encrypt the data. The private key must be known only by a receiving computing device such as the second computing device to decrypt the data. This security arrangement may be implemented so that only intended recipients are capable of decrypting the data. However, the certificate used by the recipient must be known so that the data may be properly encrypted.

### SUMMARY OF THE INVENTION

The present invention relates to a device and method for identifying a certificate. The method comprises determining, by a transmitter of data, an identity of a recipient of the data. The method comprises identifying a certificate associated with the identity. The identifying includes a local search and a remote search. The method comprises encrypting the data according to the certificate prior to transmission.

### DESCRIPTION OF THE DRAWINGS

FIG. 1 shows a network for identifying a certificate according to an exemplary embodiment of the present invention.

FIG. 2 shows a method for identifying a certificate according to an exemplary embodiment of the present invention.

### DETAILED DESCRIPTION

The exemplary embodiments of the present invention may be further understood with reference to the following description and the appended drawings, wherein like elements are referred to with the same reference numerals. The exemplary embodiments of the present invention describe a device and method for identifying a certificate used to securely transmit data from a first computing device to a second computing device. According to the exemplary embodiments of the present invention, a client application of the first computing device attempts to locate the identity of the certificate used by the second computing device automatically. The client application attempts the locating both locally and remotely. The computing devices, the certificate, the client application, and an associated method will be discussed in more detail below.

The exemplary embodiments of the present invention illustrate that the first computing device (i.e., transmitting device) is a mobile unit (MU). However, those skilled in the art will understand that the exemplary embodiments of the present invention may be applied to any computing device including mobile and non-mobile ones (e.g., desktop computer). In addition, the exemplary embodiments of the present invention relate to transmission of encrypted data. However, the exemplary embodiments of the present invention further include aspects related to the second computing device (i.e., receiving device). The aspects of the second computing device will be discussed in further detail below.

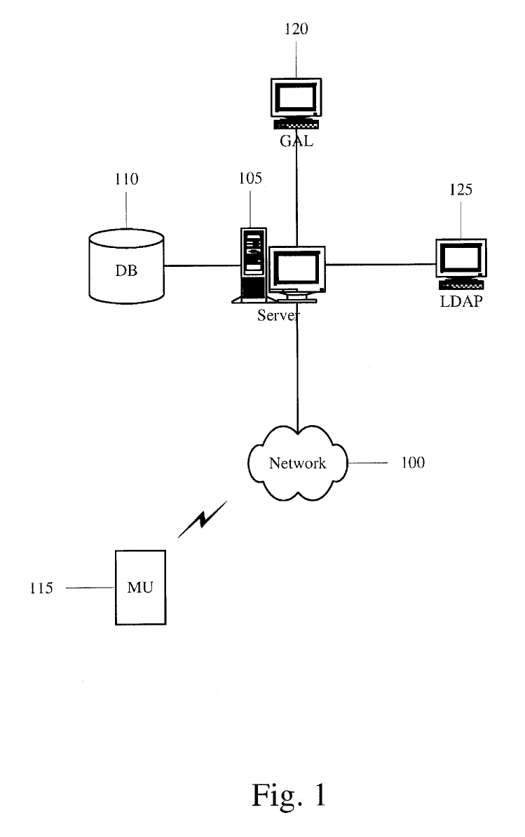

FIG. 1 shows a network 100 for identifying a certificate according to an exemplary embodiment of the present invention. The network 100 may be any communications arrangement in which at least two computing devices are capable of communicating with each other. For example, the network 100 may be a local area network (LAN), a wireless local area network (WLAN), a private area network (PAN), a wide area network (WAN), etc. The network 100 may include a server 105 and a database 110. Within an operating area of the network 100 may be a MU 115.

The server 105 may be configured to be responsible for the operations occurring within the network 100. The database 110 may store data relating to the network 100 such as association lists. The network 100 may further include other network components such as a switch to direct data appropriately, access points (AP) to extend the operating area of the network 100, a network management arrangement (NMA), etc. Those skilled in the art will understand that the components of FIG. 1 are only exemplary and that the functionality described herein of the components may reside in other devices. For example, the functionality described for the server 105 may reside in some other network node such as a switch or router. In addition, the functionality described as residing in a single device may reside in multiple devices. For example, the database 10 may be distributed to a plurality of network devices.

The MU 115 may be any mobile computing device such as a mobile computer, a personal digital assistant (PDA), a laptop, an RFID reader, a scanner, an image capturing device, a pager, etc. However, as discussed above, the MU 115 may also represent any computing device including stationary devices. The MU 115 may be disposed within an operating area of the network 100 and, thus, communicatively connected with the server 105. Accordingly, the MU 115 may include a transceiver and an antenna to exchange data with the network 100. According to the exemplary embodiments of the present invention, the MU 115 may be a transmitting device that has the capability of encrypting data prior to transmission. The encryption may be any known method.

According to the exemplary embodiments of the present invention, the MU 115 may transmit data to another computing device. Furthermore, the data may be encrypted so that only the intended recipient is capable of decrypting the data. The security arrangement for the secure transmission of data may be determined by a certificate. In order to properly encrypt the data so that the intended recipient computing device is configured to decrypt the data, the certificate utilized by the receiving computing device is also used by the MU 115.

The MU 115 may include a client application that performs the encryption according to the specifications of the certificate. According to the exemplary embodiments of the present invention, the client application may also be configured to determine the appropriate certificate and, thus, the appropriate encryption method. The client application may determine the certificate using, for example, an email address or other identifier of the receiving device.

The client application may identify the appropriate certificate from a variety of locations. For example, the client application may attempt to identify the certificate both locally and remotely. When attempting to identify the certificate locally, the client application may access a memory of the MU 115. The memory of the MU 115 may include the identity of the certificate for the intended receiving device. When attempting to identify the certificate remotely, the client application may access the database 110. The server 105 may provide applications to associated devices of the network 100 such as e-mail. The application may include respective data stored in the database 110 related to the MU 115. The database 110 may also include the identity of the certificate for the intended receiving device.

As illustrated, the server 105 may further be connected to other sources for identifying the certificate used by the intended receiving device. Accordingly, the server 105 may be connected to a communications network that includes a global address list (GAL) server 120 and a lightweight directory access protocol (LDAP) server 125. The client application may access a respective database of the GAL server 120 and the LDAP server 125. The respective database of the GAL server 120 and the LDAP server 125 may include the identity of the certificate for the intended receiving device. It should be noted that the GAL server 120 and the LDAP server 125 may be associated with the network 100. In this exemplary embodiment, the MU 115 may contact the GAL server 120 and the LDAP server 125 directly via the network 100.

The client application of the MU 115 may access any of the above described databases to identify the certificate. The client application may be configured with an order for accessing the databases. For example, the client application may be configured to attempt to use a least amount of processing to identify the certificate. In such an exemplary embodiment, the client application may first attempt to identify the certificate locally by accessing the memory of the MU 115 and proceed with accessing the GAL server 120 and then the LDAP server 125. If the client application is aware that the identity of the receiving device is new and, thus, the identity of the certificate is not stored in the memory of the MU 115, the client application may bypass accessing the memory of the MU 115 and access the GAL server 120 and the LDAP server 125.

Once the identity of the certificate is determined, the client application may encrypt the data to be transmitted. The encrypted data may be transmitted via the network 100 to the intended receiving device. For example, if the intended receiving device is associated with the network 100, the encrypted data may be transmitted via the network 100 to the switch that routes the encrypted data to the intended receiving device. In another example, if the intended receiving device is associated with a different network, the encrypted data may be transmitted via the network 100 to a further communications network that routes the encrypted data to the intended receiving device.

The intended receiving device may receive the encrypted data. Because the data is encrypted according to the certificate utilized by the receiving device, the data may be decrypted using an appropriate algorithm of the certificate.

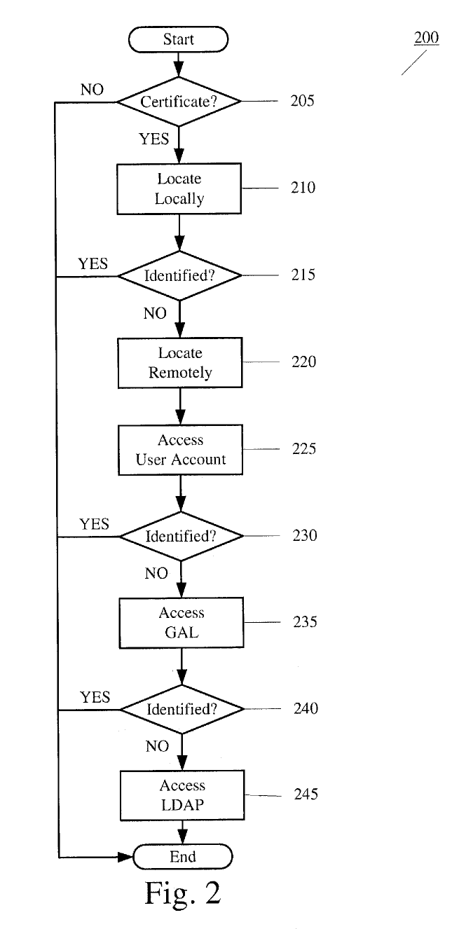

FIG. 2 shows a method 200 for identifying a certificate according to an exemplary embodiment of the present invention. The method 200 will be described according to a client application of a computing device that is to transmit encrypted data. The method 200 will be described with reference to the network 100 of FIG. 1.

In step 205, a determination is made whether a certificate is to be used. For example, a user of the MU 115 may want to transmit data to a particular party. Inputting the identity of the party may trigger the client application to search if a certificate is associated therewith. In another example, the client application may automatically assume that a certificate is associated therewith and continue with the method 200 as described below.

The exemplary embodiments of the present invention assumes that the data to be transmitted is only for intended recipients and only to be understood by the intended recipients. However, transmitted data need not require encryption, for example, if there is no confidential material. Thus, if the data to be transmitted does not require the encryption and, thus, does not require the certificate, the method 200 ends. It should be noted that all data to be transmitted may use a certificate so that all data is encrypted, whether confidential material is included or not. It should also be noted that the determination of whether to use the certificate may depend on a variety of factors. For example, a particular recipient may request that all data to be transmitted thereto requires encryption.

If step 205 determines that a certificate is to be used, the method 200 continues to step 210. In step 210, the client application of the MU 115 attempts to locate the identity of the certificate locally. As discussed above, the client application may access the memory of the MU 115. For example, if the MU 115 has already transmitted data to the intended recipient before, the client application may have saved the identity of the certificate associated with that intended recipient in the memory of the MU 115.

In step 215, a determination is made whether the certificate has been identified. The memory of the MU 115 may include the identity of the certificate. If the identity of the certificate has been identified, the method 200 ends. However, for example, if the intended recipient has no history with the user of the MU 115 that is transmitting the data, no information including the identity of the certificate may be saved on the memory of the MU 115.

If step 215 determines that the certificate has not been identified for the intended recipient, the method 200 continues to step 220 where the client application of the MU 115 attempts to locate the identity of the certificate remotely. It should be noted that the remote locating of the identity assumes that the MU 115 is associated with the network 100. Thus, in step 225, the client application may query the server 105 to access the database 110 to determine if the identity of the certificate is ascertainable. For example, the user of the MU 115 may have an email account with the network 100. The server 105 may access the email account that is saved on the database 110. If the MU 115 has already transmitted data to the intended recipient before and the identity of the certificate was not saved on the memory of the MU 115, the client application may have saved the identity of the certificate associated with that intended recipient in the email account.

In step 230, a determination is made whether the certificate has been identified. The database 110 may include the identity of the certificate. If the identity of the certificate has been identified, the method 200 ends. However, for example, again, if the intended recipient has no history with the user of the MU 115 that is transmitting the data, no information including the identity of the certificate may be saved on the database 110.

If step 230 determines that the certificate has not been identified for the intended recipient, the method 200 continues to step 235 where the client application of the MU 115 may query the server 105 to access the GAL server 120 to determine if the identity of the certificate is ascertainable. The GAL server 120 may be a database where information technology administrators or users of the same organization publish user certificates. The server 105 may access the GAL server 120 to determine if the identity of the certificate is available.

In step 240, a determination is made whether the certificate has been identified. The GAL server 120 may include the identity of the certificate. If the identity of the certificate has been identified, the method 200 ends. However, for example, the intended recipient may not be associated with the organization that owns the GAL server 120. In another example, the intended recipient may be in the same organization but that the certificate has not been published.

If step 240 determines that the certificate has not been identified for the intended recipient, the method 200 continues to step 245 where the client application of the MU 115 may query the server 105 to access the LDAP server 125 to determine if the identity of the certificate is ascertainable. The LDAP server 125 may be a central repository that includes a larger database storing certificates than the GAL server 120 or may be a certificate repository for another organization to which the recipient belongs. The server 105 may access the LDAP server 125 to determine if the identity of the certificate is available.

It should be noted that the client application of the MU 115 requesting the server 105 to access the GAL server 120 and the LDAP server 125 is only exemplary. In other exemplary embodiments of the present invention, the server 105 may enable the client application of the MU 115 to directly access the GAL server 120 and the LDAP server 125. In such an embodiment, the requesting step of the server 105 may be bypassed.

It should also be noted that the method 200 attempting the identifying in the order illustrated therein is only exemplary. That is, the local search followed by the network remote search followed by the GAL server search followed by the LDAP server search is only exemplary. The exemplary embodiments of the present invention may alter the order in which the attempts are made. For example, if the client application is aware that the intended recipient is a new user (e.g., any information regarding the intended recipient is known to be absent from the memory of the MU and the database of the network), the client application may automatically start the search at the LDAP server.

The exemplary embodiments of the present invention enable a user of a MU to identify a certificate prior to transmission of data. By identifying the certificate, an appropriate encryption may be used with the data so that an intended recipient may properly decrypt the data. Identifying the certificate may be an extensive process, in particular when the LDAP server 125 is required to be accessed (e.g., a size of the LDAP server 125 may require a high amount of processing power). The exemplary embodiments of the present invention enable the client application to search less demanding sources prior to searching more demanding sources. That is, in a preferred embodiment, because a local search is initially performed and a remote search is subsequently performed with the lesser demanding source being accessed prior to a more demanding source, the MU is not required to dedicate a predetermined amount of processing power to determine the identity of the certificate.

Those skilled in the art will understand that the above described exemplary embodiments may be implemented in any number of manners, including, as a separate software module, as a combination of hardware and software, etc. For example, the client application may be a program containing lines of code that, when compiled, may be executed on a processor of the MU 115. It should also be noted that the client application may be part of another application such as an email application.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
determining, by a transmitter of data, an identity of a recipient of the data;
identifying a certificate associated with the identity, the identifying including a local search and a remote search; and
encrypting the data according to the certificate prior to transmission.

2. The method of claim 1, wherein the local search includes accessing a memory of the transmitter.

3. The method of claim 1, wherein the remote search includes at least one of a first storage location of a network with which the transmitter of the data is associated and at least a second storage location with which the transmitter of the data is not associated.

4. The method of claim 3, wherein the second storage location includes at least a global access list (GAL) and a lightweight directory access protocol (LDAP).

5. The method of claim 1, wherein the local search and the remote search are performed in a predetermined order.

6. The method of claim 5, wherein the predetermined order includes the local search being performed prior to the remote search.

7. The method of claim 1, wherein the remote search includes a plurality of searches being performed in a predetermined order.

8. The method of claim 7, wherein the predetermined order includes accessing a GAL prior to accessing a LDAP.

9. The method of claim 1, further comprising:
determining whether the identity of the recipient is new.

10. The method of claim 9, further comprising:
bypassing the local search when the identity of the recipient is new.

11. A device, comprising:
a memory including certificate data; and
a processor executing a client application, the client application determining an identity of a recipient of data to be transmitted, the client application identifying a certificate associated with the identity, the identifying including a local search of the certificate data and a request for a remote search when the identity is not included in the certificate data, the client application encrypting the data according to the certificate prior to transmission.

12. The device of claim 11, wherein the remote search includes at least one of a first storage device of a network with which the device is associated and at least a second storage device with which the device is not associated.

13. The device of claim 12, wherein the second storage device includes at least a GAL and a LDAP.

14. The device of claim 11, wherein the local search and the remote search are performed in a predetermined order.

15. The device of claim 14, wherein the predetermined order includes the local search being performed prior to the remote search.

16. The device of claim 11, wherein the remote search includes a plurality of searches being performed in a predetermined order.

17. The device of claim 16, wherein the predetermined order includes accessing a GAL prior to accessing a LDAP.

18. The device of claim 11, wherein the processor further determines whether the identity of the recipient is new.

19. The device of claim 18, wherein the processor bypasses the local search when the identity of the recipient is new.

20. A computer readable storage medium including a set of instructions executable by a processor, the set of instructions operable to:
determine, by a transmitter of data, an identity of a recipient of the data;
identify a certificate associated with the identity, the identifying including a local search and a remote search; and
encrypt the data according to the certificate prior to transmission.
